(19) United States
(12) Patent Application Publication
(10) Pub. No.: US 2012/0139219 A1
(43) Pub. Date: Jun. 7, 2012

(54) AIRBAG CONTROL UNIT WITH IMU INTEGRATION

(75) Inventors: Sung Ho Mun, Hwaseong (KR); Jae Myung Jang, Busan (KR)

(73) Assignees: KIA MOTORS CORPORATION, Seoul (KR); HYUNDAI MOTOR COMPANY, Seoul (KR)

(21) Appl. No.: 13/090,675

(22) Filed: Apr. 20, 2011

(30) Foreign Application Priority Data
Dec. 2, 2010 (KR) 10-2010-0122043

(51) Int. Cl. B60R 21/16

(52) U.S. Cl. 280/735

(57) ABSTRACT

Provided is an airbag control unit with inertial measurement unit (IMU) integration, which includes an airbag collision sensor configured to detect airbag collision information; a digital sensor configured to detect a yaw rate and an acceleration, and to convert a detected data to a digital signal; and a micom configured to identify whether an output from the digital sensor and an output from the airbag collision sensor are within a measurement range of a corresponding sensor.

### CROSS-REFERENCES TO RELATED APPLICATIONS

Priority to Korean patent application number 10-2010-122043, filed on Dec. 2, 2010, which is hereby incorporated by reference in its entirety, is claimed.

### BACKGROUND OF THE INVENTION

1. Field of the Invention

The present invention relates to an airbag control unit with inertial measurement unit (IMU) integration, and more particularly, to a technology for integrating a yaw rate sensor and vertical/horizontal gravity sensors (G sensor), which are formed as a separate unit and connected to an electronic stability control (ESC) unit, with an airbag control unit (ACU), thereby improving a layout of an in-vehicle device.

2. Description of the Related Art

A yaw rate sensor and a G sensor are sensors that are necessary to perform steering control of a vehicle. Specifically, the yaw rate sensor is a sensor that measures a vehicle's yaw rate (angular velocity) around a vertical axis of the vehicle and is used for 4 wheel steering control of the vehicle. The G sensor (gravity sensor), which is also called an accelerometer sensor, processes an output signal to measure moving inertia of the vehicle.

As shown in FIG. 1, the yaw rate sensor and the G sensor include an electronic stability control (ESC) unit 10 and a sensor unit, which is formed as a separate unit from the ESC unit 10.

As illustrated in FIG. 1, the sensor unit (inertial measurement unit (IMU)) 20 includes a vertical G sensor unit 40 for detecting acceleration along an X axis. The sensor unit also includes a horizontal G/yaw rate sensor unit 50 for detecting acceleration along a Y axis and a yaw rate.

The vertical G sensor 40 includes an X-axis acceleration sensor 41 and a power supply unit 40. The horizontal G/yaw rate sensor unit 50 includes a yaw rate sensor 51, a Y axis acceleration sensor 52, a micom 55 and a power supply unit 54. In the conventional design shown in FIG. 1, the airbag control unit (ACU) 30 includes an airbag collision sensor 31, which includes an acceleration sensor and a roll rate sensor, a micom 32 and a power supply unit 33.

As shown in FIG. 2, a value sensed by the sensor unit 20 is transmitted to the ESC unit 10 where filters 11 and 12 of the ESC 10 perform filtering on the sensed value. Then an A/D converter 13 converts the sensed value to a digital signal and a determination unit 16 determines whether the converted digital signal is an appropriate signal by comparing the digital signal with a self-test signal. Next, a computation unit 18 conducts computation for performing calibration and a calibration unit 17 performs offset calibration on the digital signal.

Thus, in a related art, the yaw rate sensor and the vertical/horizontal G sensors are formed as a separate unit from the ESC unit 10, thereby occupying a larger portion of an in-vehicle area.

In addition, because the ESC 10 performs the filtering, calibration, and determination on an output value of the yaw rate sensor and the vertical/horizontal G sensors, a heavy load is applied to the ESC unit 10.

### SUMMARY OF THE INVENTION

The present invention provides an airbag control unit that is integrated with a digital sensor, in which a separate yaw rate sensor and separate vertical/horizontal G sensors are integrated, so that a layout of an in-vehicle device can be improved.

In addition, an output value of the yaw rate sensor and the vertical/horizontal G sensors are processed by a micom of the airbag control unit so that a load applied to the ESC unit can be reduced.

In accordance with an aspect of the present invention, an airbag control unit with inertial measurement unit (IMU) integration is provided. The airbag control unit in this embodiment of the present invention may include an airbag collision sensor configured to detect an airbag collision information; a digital sensor configured to detect a yaw rate and an acceleration. The digital sensor in the airbag control unit may also be configured to convert a detected data to a digital signal. Additionally, a micom may be configured to identify whether an output from the digital sensor and an output from the airbag collision sensor are within a measurable range of a corresponding sensor.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The objects, features and advantages of the present invention will be more apparent from the following detailed description in conjunction with the accompanying drawings, in which:

FIG. 1 is a diagrammatic view illustrating a conventional configuration in which a yaw rate sensor and a conventional vertical/horizontal G sensor are installed;

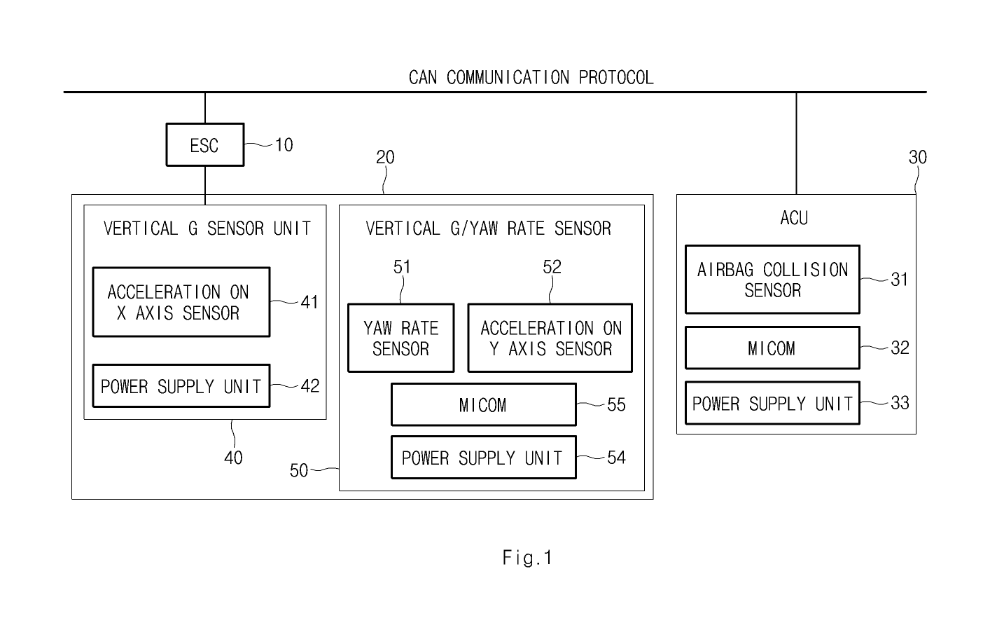

FIG. 2 is a diagrammatic view for explaining the flow of an output signal of the conventional yaw rate sensor and the conventional vertical/horizontal G sensor in FIG. 1;

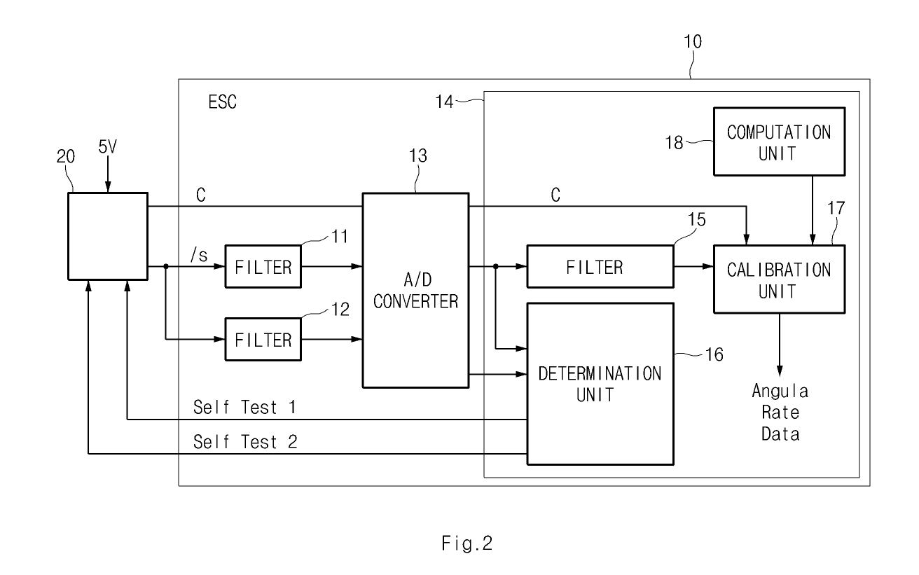

FIG. 3 is a diagrammatic view illustrating a configuration of an airbag control unit with IMU integration according to an exemplary embodiment of the present invention; and

FIG. 4 is a diagrammatic view illustrating an exemplary detailed configuration of a digital sensor and a micom in FIG. 3.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

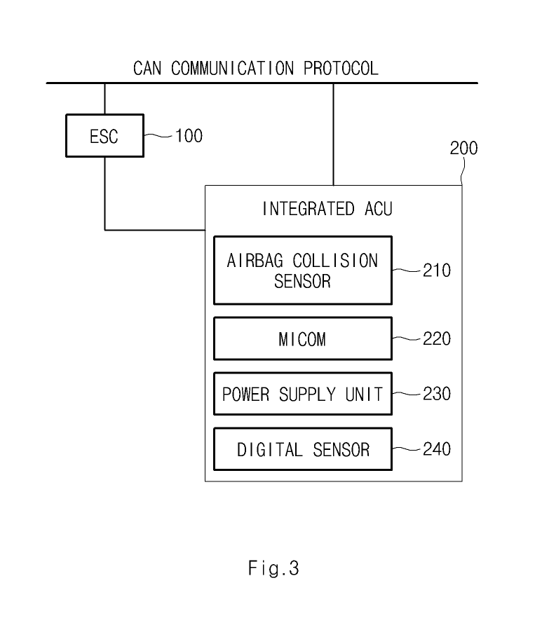

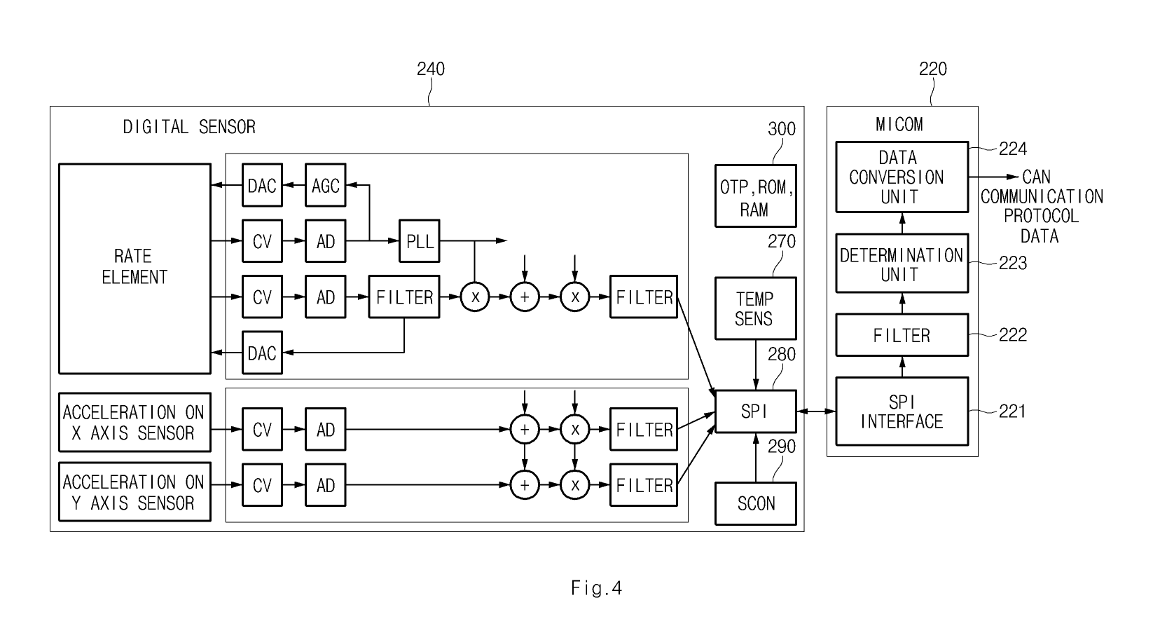

Hereinafter, an airbag control unit with IMU integration according to the present invention will be described with reference to FIGS. 3 and 4.

FIG. 3 is a view illustrating a configuration of an airbag control unit (ACU) with IMU integration according to an exemplary embodiment of the present invention. The integrated ACU 200 with IMU integration according to an exemplary embodiment of the present invention includes an airbag collision sensor 210, a micom 220, a power supply unit 230 and a digital sensor 240.

Specifically, the airbag collision sensor 210 is used to sense acceleration and roll rate. The micom 220 filters and measures an output value of the airbag collision sensor 210 and an output value of the digital sensor 240, and performs a data conversion thereon to enable controller area network (CAN) communication. To this end, the micom 220 includes an SPI interface 221, a filter 222, a determination unit 223 and a data conversion unit 224, as shown in FIG. 4.

The SPI interface 221 receives the output value of the digital sensor 240 that is output in an SPI mode. The filter 222 filters data received at the SPI interface 221, and the determination unit 223 detects an error condition of the filtered data by identifying whether the filtered data is within a measurable range of the sensor. The data conversion unit 224 converts data outputted from the determination unit 223 to a data in compliance with CAN communication protocol and transmits the converted data to an electronic stability control (ESC) unit 100.

The power supply unit 230 provides power to the airbag collision sensor 210, the micom 220 and the digital sensor 240.

The digital sensor 240 measures dynamic force such as a vehicle's yaw rate (angular velocity) around a vertical axis of the vehicle, acceleration along an X-axis and a Y-axis of the vehicle, and vibration and impact of the vehicle The digital sensor then converts the detected value to a digital signal, and performs filtering and calibration on the converted digital signal.

To this end, the digital sensor 240 may have the exemplary detailed configuration as shown in FIG. 4.

In FIG. 4, the digital sensor 240 includes a digital-to-analog converter (DAC) for converting a digital signal to an analog signal, a capacitance-to-voltage conversion (CV), an automatic gain control (AGC) for controlling a gain of a received signal, an analog-to-digital (AD) converter for converting an analog sensing value into a digital signal, a phase locked loop (PLL), a filter FILTER for filtering a signal, an one-time programmable (OTP) 300, a safety controller (SCON) 290 for performing an offset calibration according to vehicle set-up conditions, a temperature sensor (TEMP SENS) 270 for correcting an output according to temperature characteristics, and a serial peripheral interface (SPI) 280 for outputting a corrected value in the SPI mode.

The digital sensor 240 converts the yaw rate value and the acceleration value, which are physically measured, to a digital signal, and performs filtering and calibration on the digital signal to send to the micom 220. Next, the micom 220 filters the calibrated data, identifies whether the data is within a measurable range of the sensor, and converts the data into a data in compliance with the CAN protocol. The converted data is outputted to a CAN communication bus so that the data is transmitted to the ESC unit 100.

As described above, according to the present invention, a micom 220 and a power supply unit 230 of an integrated ACU 200 can be used in replacement of the power supply unit 42 of the vertical G sensor unit 40 and the micom 55 and the power supply unit 54 of the horizontal G/yaw rate sensor unit 50, thereby providing an improved layout and reducing the number of components, which results in lower manufacturing costs.

In addition, according to the present invention, the output of the yaw rate sensor and the output of the vertical/horizontal G sensor are processed through the micom of the air bag control unit, thereby minimizing a load of ESC unit.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An airbag control unit with inertial measurement unit (IMU) integration, the airbag control unit comprising:
an airbag collision sensor configured to detect an airbag collision information;
a digital sensor configured to detect a yaw rate and an acceleration, and configured to convert a detected data to a digital signal; and
a micom configured to identify whether an output from the digital sensor and an output from the airbag collision sensor are within a measurement range of a corresponding sensor.

2. The airbag control unit with IMU integration of claim 1, wherein the digital sensor performs filtering, temperature calibration and offset calibration on the digital signal.

3. The airbag control unit with IMU integration of claim 2, wherein the micom filters a calibrated output from the digital sensor, performs the identification, and converts the identified data into a data in compliance with a controller area network (CAN) communication protocol.

4. The airbag control unit with IMU integration of claim 1, wherein the digital sensor converts a yaw rate sensing value and acceleration values for an X axis and a Y axis into respective digital signals.

5. The airbag control unit with IMU integration of claim 2, wherein the digital sensor converts a yaw rate sensing value and acceleration values for an X axis and a Y axis into respective digital signals.

6. The airbag control unit with IMU integration of claim 3, wherein the digital sensor converts a yaw rate sensing value and acceleration values for an X axis and a Y axis into respective digital signals.

7. The airbag control unit with IMU integration of claim 1, further comprising:
a power supply unit configured to provide a power to the digital sensor, the airbag collision sensor, and the micom.

8. The airbag control unit with IMU integration of claim 2, further comprising:
a power supply unit configured to provide a power to the digital sensor, the airbag collision sensor, and the micom.

9. An airbag control unit with inertial measurement unit (IMU) integration, the airbag control unit comprising:
a first sensor configured to detect an airbag collision information;
a second sensor configured to detect data related to a yaw rate and an acceleration, and convert the detected data to a digital signal; and
a micom configured to identify whether an output from the second sensor and an output from the first sensor are within a predetermined range of a corresponding sensor.

10. The airbag control unit with IMU integration of claim 1, wherein
the first sensor is an air bag control sensor and the second sensor is a digital sensor,
the data detected a yaw rate and an acceleration, and
the digital sensor performing filtering, temperature calibration and offset calibration on the digital signal.

11. The airbag control unit with IMU integration of claim 10, wherein the micom filters a calibrated output from the digital sensor, performs the identification, and converts the identified data into a data in compliance with a controller area network (CAN) communication protocol.

12. The airbag control unit with IMU integration of claim 10, wherein the digital sensor converts a yaw rate sensing value and acceleration values for an X axis and a Y axis into respective digital signals.

13. The airbag control unit with IMU integration of claim 10, wherein the digital sensor converts a yaw rate sensing value and acceleration values for an X axis and a Y axis into respective digital signals.

14. The airbag control unit with IMU integration of claim 10, further comprising:
a power supply unit configured to provide a power to the digital sensor, the airbag collision sensor, and the micom.

15. A method for operating an airbag control unit with inertial measurement unit (IMU) integration, the method comprising:
detecting, by a first sensor, airbag collision information;
detecting, by a second sensor, data related to a yaw rate and an acceleration;
converting, by the second sensor, the detected data to a digital signal; and
identifying by a micom whether an output from the second sensor and an output from the first sensor are within a predetermined range of a corresponding sensor.
